(19) United States
(12) Patent Application Publication
(10) Pub. No.: US 2017/0019246 A1
(43) Pub. Date: Jan. 19, 2017

(54) COMMUNICATION SYSTEM, ELECTRONIC APPARATUS, COMMUNICATION METHOD AND PROGRAM

(71) Applicant: SEIKO INSTRUMENTS INC., Chiba-shi, Chiba (JP)

(72) Inventors: Kazuhiro KOYAMA, Chiba-shi, Chiba (JP); Kenji OGASAWARA, Chiba-shi, Chiba (JP); Akira TAKAKURA, Chiba-shi, Chiba (JP)

(21) Appl. No.: 15/124,437

(22) PCT Filed: Nov. 18, 2014
(86) PCT No.: PCT/JP2014/080407

§ 371 Date: Sep. 8, 2016

(30) Foreign Application Priority Data
Mar. 11, 2014 (JP) 2014-047936

(51) Int. Cl. H04L 7/00; H04L 1/18; G04G 5/00; H04L 1/08

(52) U.S. Cl. CPC H04L 7/0075; H04L 1/08; H04L 1/188; G04G 5/00

(57) ABSTRACT

A proposed electronic apparatus is capable of transmitting correct data by re-transmitting data without complicating communication processing even when a delay occurs in transmission processing of data in one-way communication. An electronic apparatus 10 transmits data to an electronic timepiece 20 as an optical signal by using a light source 103 which transmits the optical signal, determining whether a delay has occurred in transmission of the data or not, and re-transmitting the data by using the light source 103 when a delay has occurred. The electronic timepiece 20 enables data which has been normally received in the case where a solar cell 201 has received data from the electronic apparatus 10 plural times.

### TECHNICAL FIELD

The present invention relates to a communication system, an electronic apparatus, a communication method and a program.

The present invention claims a priority based on the Japanese Patent Application No. 2014-047936 filed on Mar. 11, 2014, all the contents of which are cited in this document.

### BACKGROUND ART

There exists a time correction system in which time data for correcting time is transmitted from an LED (Light Emitting Diode) or the like of an electronic apparatus and received by a solar panel of a timepiece to thereby correct the time of the timepiece. In such system, a delay may occur in transmission processing of an optical pulse signal in a case where a processing load of the electronic apparatus is increased due to system constraints of the electronic apparatus and other cases. It is difficult to control the delay by a timer in communication because of system constraints. It is difficult for the timepiece to obtain correct time data when receiving the signal in which the delay occurs.

In Patent Literature 1, there is disclosed an asynchronous packet communication method of reducing a system burden due to a request or a retry request by increasing the number of retry transmission when an error occurs. In Patent Literature 2, there is disclosed a data transmission device capable of performing communication with a non-contact type data carrier in good condition also under an environment where pulse noise occurs by predicting a period of occurrence of pulse noise.

### CITATION LIST

### Patent Literature

Patent Literature 1: JP-A-2006-129125

Patent Literature 2: JP-A-2008-028641

### SUMMARY OF INVENTION

### Technical Problem

However, there is a problem in the technique disclosed in Patent Literature 1 that it is difficult to send the retry if there is no reply as the occurrence of an error is determined based on a reply from a communication partner. Furthermore, a signal is not able to be sent from the timepiece as a time correction system of the timepiece is basically performed by one-way communication, therefore, the retry is not performed as there is no means for responding even when the occurrence of the error can be determined. The processing capacity of a CPU (Central Processing Unit) of the timepiece is not high in general. Accordingly, the error correction processing is not performed in the time correction system for preventing complication in communication processing. In Patent Literature 2, there is a problem that the technique does not supported by an environment where pulse noise is generated in a fixed period.

The present invention has been made in view of the above circumstances, and an object thereof is to provide a communication system, an electronic apparatus, a communication method and a program capable of transmitting correct data by re-transmitting data without complicating communication processing even when a delay occurs in transmission processing of data in one-way communication.

### Solution to Problem

According to some embodiments of the present invention, there is provided a communication system including a first electronic apparatus and a second electronic apparatus, in which the first electronic apparatus has a transmission unit transmitting an optical signal, and a transmission controller transmitting data to the second electronic apparatus as the optical signal by using the transmitting unit, determining whether a delay has occurred in transmission of the data or not and re-transmitting the data by using the transmission unit when determining that the delay has occurred, and the second electronic apparatus has a receiving unit receiving the optical signal of the data from the first electronic apparatus, and a controller enabling the data which has been normally received in the case where the receiving unit has received the data plural times.

In the communication system according to another aspect of the present invention, the transmission controller may determine that the delay has occurred in transmission of the data in the case where a period of time from the start of transmission to the end of transmission of the data is equal to or longer than a predetermined period of time.

In the communication system according to another aspect of the present invention, the transmission controller may re-transmit the data after transmitting a retry synchronization signal when re-transmitting the data, and the controller may enable data received after the retry synchronization signal when the receiving unit receives the retry synchronization signal.

In the communication system according to another aspect of the present invention, the transmission controller may transmit the data after a predetermined period of time passes when re-transmitting the data.

In the communication system according to another aspect of the present invention, the transmission controller may transmit an end signal when transmission of the data is completed, and the controller may enable the data received just before the end signal.

According to the embodiment of the present invention, there is provided an electronic apparatus including a transmission unit transmitting an optical signal and a transmission controller transmitting data to another electronic apparatus as the optical signal by using the transmitting unit, determining whether a delay has occurred in transmission of the data or not and re-transmitting the data by using the transmission unit when determining that the delay has occurred.

According to the embodiment of the present invention, there is provided an electronic apparatus including a receiving unit receiving an optical signal of data from another electronic apparatus, and a controller enabling the data which has been normally received in the case where the receiving unit has received the data plural times.

According to the embodiment of the present invention, there is provided a communication method in a communication system including a first electronic apparatus and a second electronic apparatus, which includes the steps of performing transmission control by transmitting data to the second electronic apparatus as an optical signal by using a transmission unit which transmits the optical signal by the first electronic apparatus, determining whether a delay has occurred in transmission of the data or not and re-transmitting the data by using the transmission unit when occurrence of the delay is determined, receiving the optical signal of the data from the first electronic apparatus by the second electronic apparatus and performing control of enabling the data which has been normally received when the data has been received plural times by the second apparatus in the receiving step.

According to the embodiment of the present invention, there is provided a program for allowing a computer to execute the step of performing transmission control by transmitting data to another electronic apparatus as an optical signal by using a transmission unit which transmits the optical signal, determining whether a delay has occurred in transmission of the data or not and re-transmitting the data by using the transmission unit when occurrence of the delay is determined.

A program allowing a computer to execute the steps of receiving an optical signal of data from another electronic apparatus and performing control of enabling the data which has been normally received when the data has been received plural times in the receiving step.

### Advantageous Effects of Invention

According to the present invention, the transmission controller of the first electronic apparatus transmits data to the second electronic apparatus as the optical signal by using the transmitting unit, determining whether a delay has occurred in transmission of the data or not and re-transmitting the data by using the transmission unit when determining that the delay has occurred. The control unit of the second apparatus enables the data which has been normally received in the case where data is received plural times. Accordingly, even when a delay occurs in transmission processing of data in one-way communication, correct data can be transmitted by re-transmitting the data without complicating communication processing.

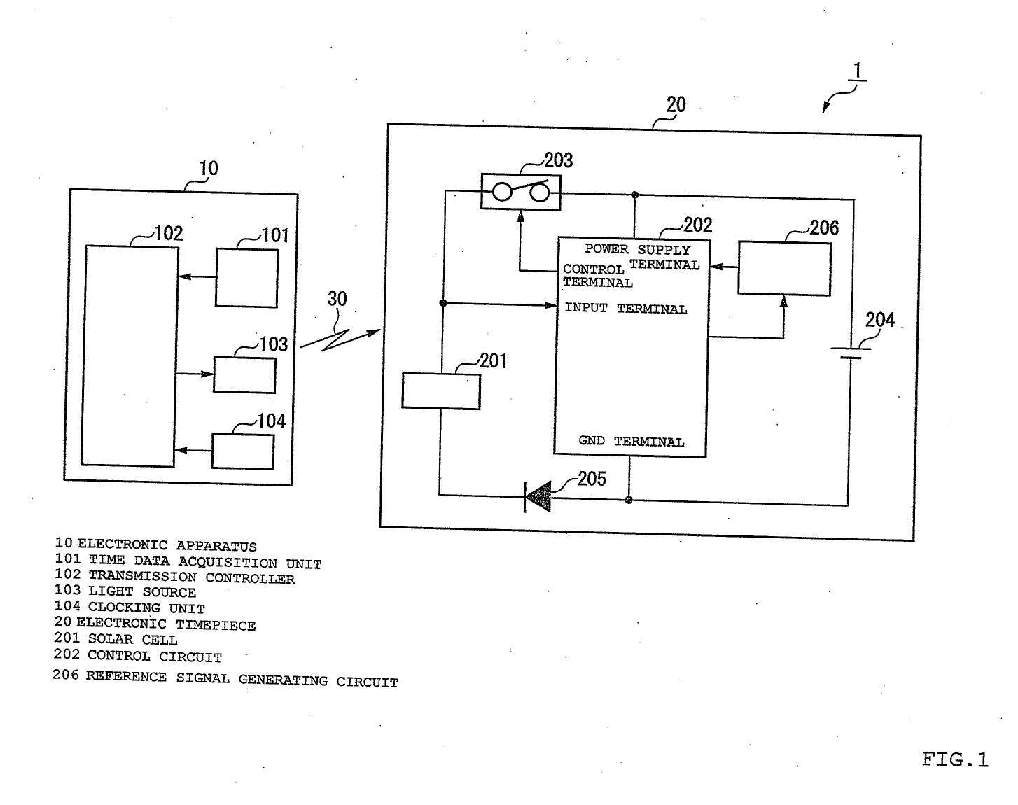

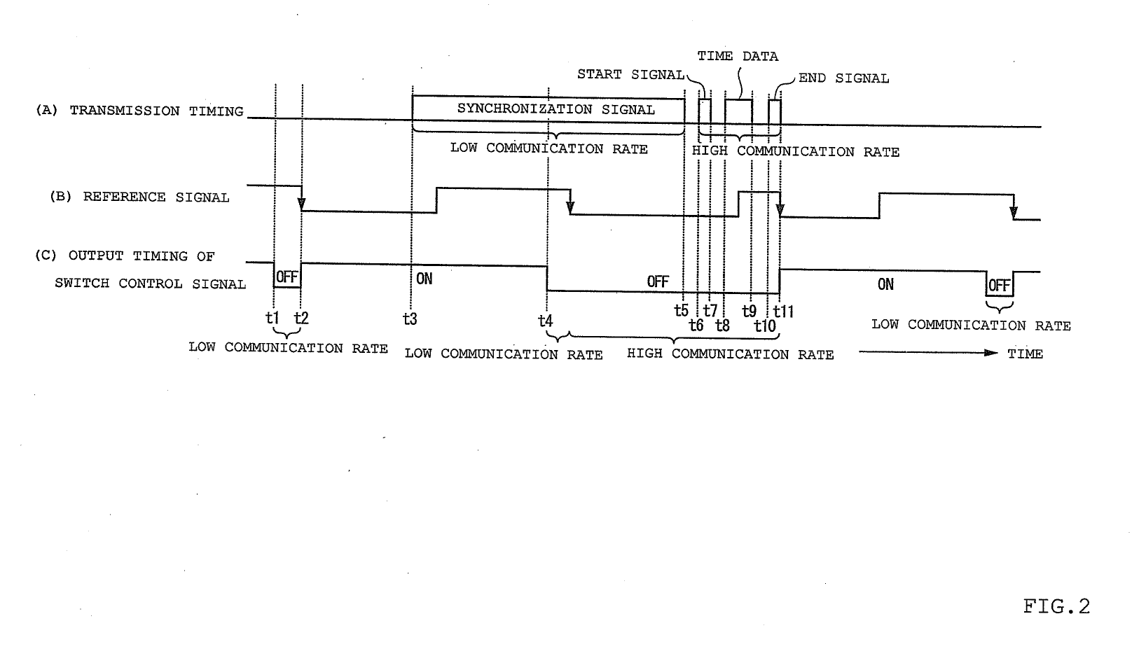

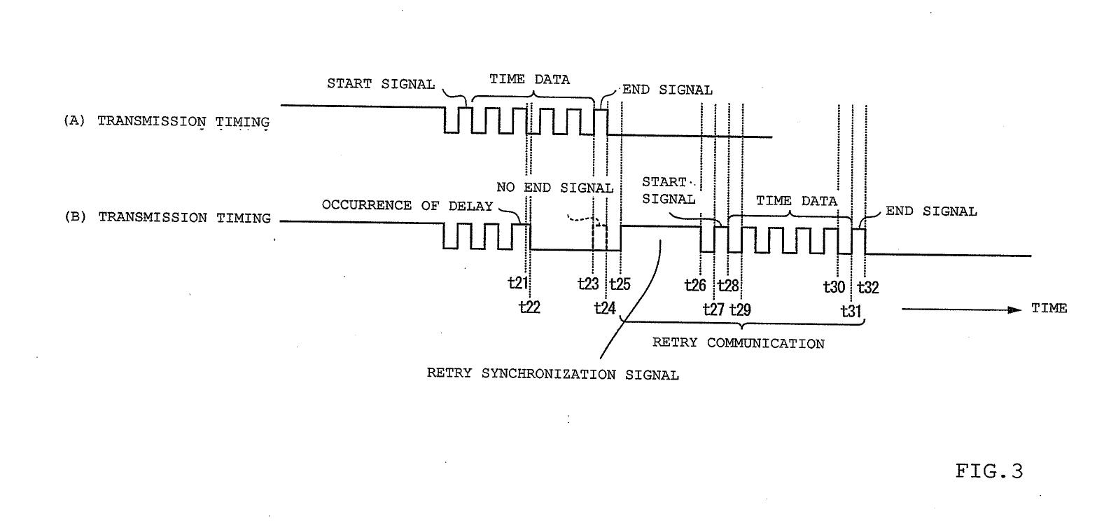

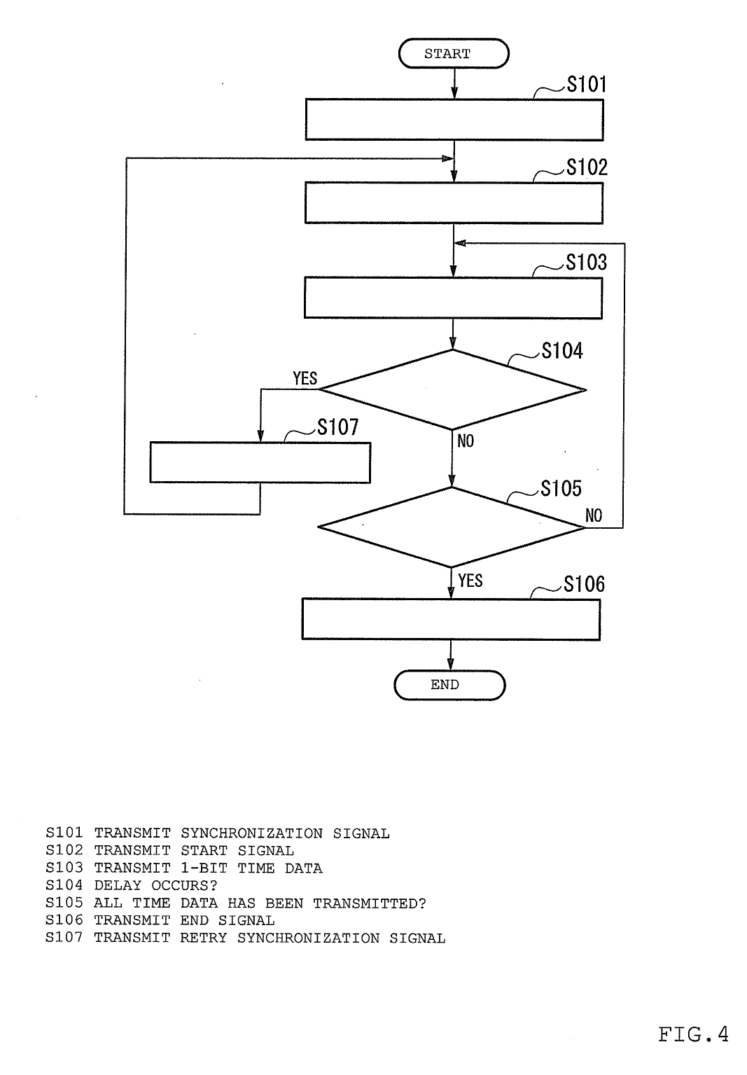

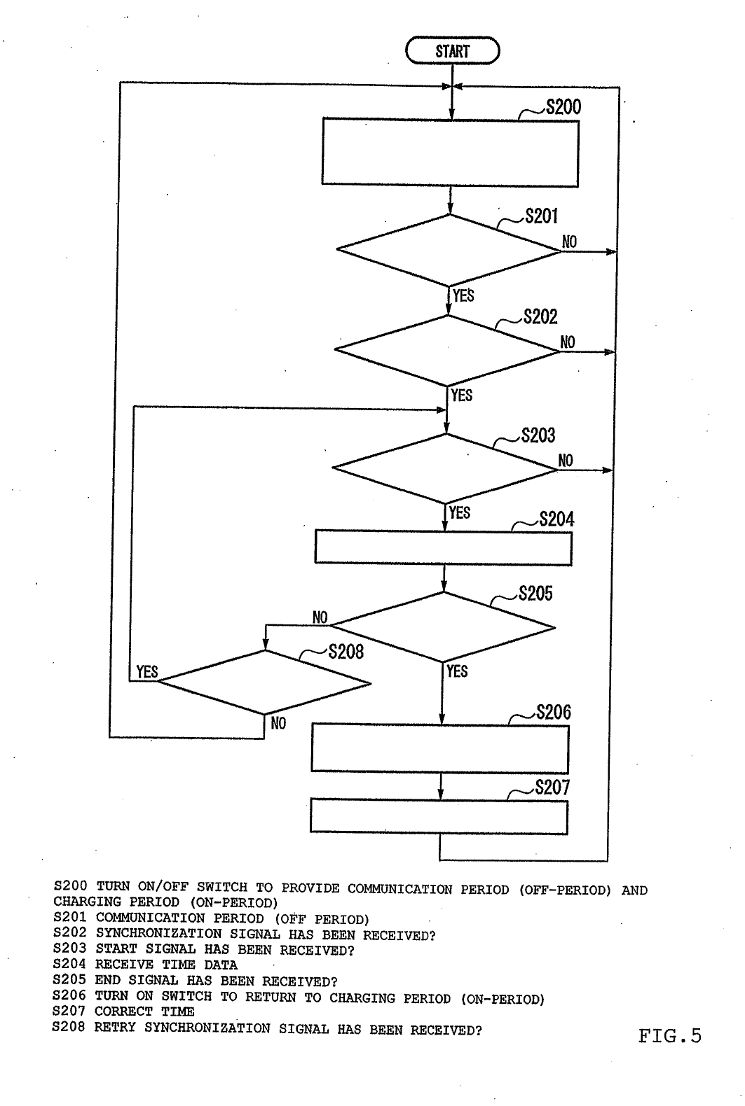

### BRIEF DESCRIPTION OF DRAWINGS

[FIG. 1] FIG. 1 is a schematic diagram showing a configuration of a communication system according to an embodiment of the present invention.

[FIG. 2] FIG. 2 shows timing charts for explaining an operation example of an electronic timepiece according to the embodiment of the present invention.

[FIG. 3] FIG. 3 shows timing charts for explaining an operation example of an electronic apparatus according to the embodiment of the present invention.

[FIG. 4] FIG. 4 is a flowchart showing processing procedures of communication processing executed by the electronic apparatus according to the embodiment.

[FIG. 5] FIG. 5 is a flowchart showing processing procedures of communication processing executed by the electronic timepiece according to the embodiment.

### DESCRIPTION OF EMBODIMENTS

Hereinafter, an embodiment of the present invention will be explained with reference to the drawings. FIG. 1 is a schematic diagram showing a configuration of a communication system 1 according to the embodiment. In the shown example, the communication system 1 includes an electronic apparatus 10 (first electronic apparatus) and an electronic timepiece 20 (second electronic apparatus). The electronic apparatus 10 is an electronic apparatus such as a smart phone, a cellular phone device or a tablet terminal. In the shown example, the electronic apparatus 10 includes a time data acquisition unit 101, a transmission controller 102, a light source 103 and a clocking unit 104.

The time data acquisition unit 101 acquires the present date and time (present time (hour, minute, second) and present date (year, month, day). For example, the time data acquisition unit 101 uses a method of acquiring the present date and time by accessing a time server on Internet, a method of acquiring the present date and time by using GPS (Global Positioning System) or a method of acquiring the present date and time from a control signal from a base station. Any method of acquiring the present date and time may be applied.

The transmission controller 102 performs control of respective sections included in the electronic apparatus 10. The transmission controller 102 also generate time data for correcting the time of the electronic timepiece 20 based on the present date and time acquired by the time data acquisition unit 101. Then, the transmission controller 102 outputs (transmits) the generated time data as an optical signal by using the light source 103.

The transmission controller 102 determines whether a delay has occurred or not in transmission processing of the time data. For example, the transmission controller 102 determines that the delay has occurred in the transmission of data in the case where a period of time from the start of transmission to the end of transmission of data is equal to or longer than a predetermined period of time. Specifically, the transmission controller 102 measures the time from the start of transmission to the end of transmission of data when transmitting a predetermined amount of time data (for example, 1-bit). Then, the transmission controller 102 determines that the delay has occurred in transmission of data when the period of time from the start of transmission to the end of transmission of data is equal to or longer than the predetermined period of time.

The method of determining whether the delay has occurred in transmission processing of time data or not is not limited to the above. For example, the transmission controller 102 executes a program of transmitting an optical signal. Then, the transmission controller 102 determines whether the processing delay has occurred or not by comparing a period of time clocked by the program (a period of time counted by a timer) with a period of time clocked by the clocking unit 104.

Specifically, the transmission controller 102 acquires the time clocked by the clocking unit 104 and sets the timer when transmitting a predetermined amount (for example, 1-bit) of time data. Then, the transmission controller 102 may determine that the processing delay has occurred in the case where an elapsed time based on the present time is a predetermined period of time longer than an elapsed time counted by the timer as a result of comparing the elapsed time from the start of transmission to the end of transmission based on the present time clocked by the clocking unit 104 with the elapsed time counted by the timer.

The transmission controller 102 re-outputs (re-transmits) time data as an optical signal by using the light source 103 in the case where it is determined the delay has occurred in the transmission processing of time data. The transmission controller 102 transmits time data after transmitting a retry synchronization signal indicating that data is re-transmitted when re-transmitting time data. The transmission controller 102 transmits an end signal when time data is transmitted without delay.

The light source 103 is, for example, an LED for a flash provided in the electronic apparatus 10, a backlight of a liquid crystal display and so on. The light source 103 operates as a transmission unit transmitting an optical signal indicating time data to the electronic timepiece 20. The clocking unit 104 is a real-time clock including an oscillation circuit generating an oscillation signal of a given frequency and a CPU, which clocks time.

The electronic timepiece 20 is a timepiece displaying time in analog display. In the shown example, the electronic timepiece 20 includes a solar cell 201, a control circuit 202, a switch 203, a secondary battery 204, a diode 205 and a reference signal generating circuit 206.

The solar cell 201 operates as a power generator receiving light (sun, illumination and so on) and converting the light into electrical energy in a charging period. The solar cell 201 operates as a receiving unit performing optical communication with the electronic apparatus 10 and receiving the optical signal indicating time data from the electronic apparatus 10 in a communication period. The charging period and the communication period will be described later.

The control circuit 202 performs control of respective sections included in the electronic timepiece 20. The control circuit 202 also controls charging to the secondary battery 204 by the solar cell 201. The control circuit 202 also controls prevention of overcharge in the secondary battery 204. Furthermore, the control circuit 202 performs optical communication by using the solar cell 201.

For example, the control circuit 202 is actuated by power outputted by the secondary battery 204 connected to a power supply terminal and a GND terminal. In this case, the control circuit 202 detects an output voltage of the secondary battery 204, thereby determining a charging state (full-charge, overcharge and so on) of the secondary battery 204 to perform given control of charging. For example, the control circuit 202 performs ON/OFF control of the switch 203 by a control signal outputted from a control terminal depending on the charging state of the secondary battery 204. Accordingly, the control circuit 202 charges the secondary battery 204 by connecting the solar cell 201 to the secondary battery 204. The control circuit 202 prevents overcharge of the secondary battery 204 by cutting off the connection between the solar cell 201 and the secondary battery 204.

The control circuit 202 also outputs a switch control signal based on a reference signal outputted by the reference signal generating circuit 206 to perform ON/OFF control of the switch 203. Accordingly, the control circuit 202 connects the solar cell 201 to the secondary battery 204 and cuts off the connection between the solar cell 201 and the secondary battery 204.

The control circuit 202 (controller) also detects an output voltage of the solar cell 201 inputted to an input terminal and converts the detected voltage into an electrical signal to thereby receive time data transmitted from an external apparatus (the electronic apparatus 10 in the embodiment) by optical communication during the communication period. The control circuit 202 also enables time data which has been received lastly in the case where time data has been received plural times during one communication period. For example, the control circuit 202 enables time data received after the retry synchronization signal, which is time data received just before an end signal when receiving the retry synchronization signal. Then, the control circuit 202 corrects the time shown by hands based on the enabled time data.

The switch 203 connects the solar cell 201 and the secondary battery 204 and cuts off the connection between the solar cell 201 and the secondary battery 204 based on the switch control signal inputted from the control signal 202. The secondary batter 204 supplies power to respective sections included in the electronic timepiece 20. The diode 205 prevents reverse flow of electric current with respect to the secondary battery 204. The reference signal generating circuit 206 includes an oscillation circuit (for example, 32 kHz) and a divider circuit, which generates a reference signal of, for example, 1 Hz.

Next, a communication method between the electronic apparatus 10 and the electronic timepiece 20 will be explained. In the embodiment, the electronic apparatus 10 transmits data by using the light source 103. For example, the electronic apparatus 10 allows the light source 103 to emit light when transmitting “1” and turns off the light source 103 when transmitting “0”. The electronic timepiece 20 receives data by using the solar battery 201. For example, the control circuit 202 of the electronic timepiece 20 determines that “1” has been received when the solar cell 201 receives light and generates the voltage, and determines that “0” has been received when the solar cell 201 does not generate the voltage.

When the solar cell 201 is connected to the secondary battery 204, it is difficult to determine the voltage generated by the solar cell 201 accurately due to the output voltage of the secondary battery 204. Accordingly, the solar cell 201 is separated from the secondary battery 204 by controlling the switch 203 for detecting the voltage generated by the solar cell 201 more accurately at the time of receiving data in the embodiment. The period during which the solar cell 201 is separated from the secondary battery 204 is regarded as a “communication period (OFF period)”.

In periods other than the communication period, the solar cell 201 is connected to the secondary battery 204 by controlling the switch 203. A period during which the solar cell 201 is connected to the secondary battery 204 is regarded as a “charging period (ON period)”. Accordingly, data can be received more accurately in the communication period.

The secondary battery 204 is not able to be charged in the communication period. Accordingly, the communication period is desirably short. Therefore, the electronic timepiece 20 is normally in the charging period, and short communication periods are provided periodically in the embodiment. Then, the electronic timepiece 20 continues the communication period until receiving the end signal when the synchronization signal is received from the electronic apparatus 10 in the short communication period. On the other hand, the electronic timepiece 20 is in the charging period while the synchronization signal is not received from the electronic apparatus 10 in the communication period.

FIG. 2(A) is a timing chart showing the transmission timing of a synchronization signal, a start signal, a time data and an end signal to be transmitted to the electronic timepiece 20 by the electronic apparatus 10. FIG. 2 (B) is a timing chart showing the output timing of a reference signal generated by the reference signal generating circuit 206. FIG. 2(C) is a timing chart showing the output timing of the switch control signal outputted by the control circuit 202 of the electronic timepiece 20.

As shown in FIG. 2(A), the electronic apparatus 10 transmits the synchronization signal at a low communication rate in which the communication rate is low when transmitting time data (time t3 to time t5). After that, the electronic apparatus 10 shifts to a high communication rate which is higher than the low communication rate (for example, four times of the low communication rate) and transmits the start signal (time t6 to time t7). After that, the electronic apparatus 10 transmits time data (time t8 to time t9). After that, the electronic apparatus 10 transmits the end signal (time t10 to t11).

Moreover, as shown in FIG. 2 (B), the electronic timepiece 20 switches the reference signal between a low-level period and a high-level period periodically. The electronic timepiece 20 resets the reference signal generated by the reference signal generating circuit 206 when the reception of the end signal is completed (time t11).

As shown in FIG. 2(C), the electronic timepiece 20 turns off the switch 203 and shifts to the communication period at the low communication rate after a fixed period of time passes from the transition to the charging period (time t1). The electronic timepiece 20 turns on the switch 203 and shifts to the charging period after a fixed period of time passes from the transition to the communication period without receiving the synchronization period (time t2). The electronic timepiece 20 also turns off the switch 203 and shifts to the communication period after the fixed period of time passed from the transition to the charging period (time t4).

As the synchronization signal is transmitted from the electronic apparatus 10 at time t4, the electronic timepiece receives the synchronization signal. As the synchronization signal is received, the electronic timepiece 20 is in the communication period at the high communication rate until time t11 when the reception of the end signal is completed. The electronic timepiece 20 shifts to the charging period when the reception of the end signal is completed (time t11). After that, the electronic timepiece 20 repeats the charging period and the communication period based on the reference signal in the same manner, thereby receiving time data transmitted from the electronic apparatus 10.

As described above, the electronic timepiece 20 repeats the charging period and the communication period which is shorter than the charging period. When the synchronization signal is received in the short communication period, the communication period is continued until the reception of the end signal is completed. Accordingly, the electronic timepiece 20 can receive the optical signal more accurately while allowing the charging period to be longer.

The electronic time piece 20 detects the synchronization signal at the low communication rate first in the communication period, switching the rate to the high communication rate (for example, four times of the low-speed communication rate) after the detection of the synchronization signal, thereby receiving the start signal, time data and the end signal. The electronic apparatus 10 transmits the synchronization signal at the low communication rate, and transmits the start signal, time data and the end signal at the high communication rate after the synchronization signal is transmitted. Accordingly, power consumption of the electronic apparatus 10 and the electronic timepiece 20 can be reduced.

FIG. 3(A) is a timing chart showing the transmission timing of a signal transmitted to the electronic timepiece 20 by the electronic apparatus 10 in the case where a processing delay does not occur. FIG. 3(B) is a timing chart showing the transmission timing of a signal transmitted to the electronic timepiece 20 by the electronic apparatus 10 in the case where the processing delay has occurred.

As shown in FIG. 3(A), the electronic apparatus 10 transmits the end signal after transmitting time data when the processing delay does not occur during the transmission of time data (time t23 to t24).

On the other hand, as shown in FIG. 3 (B), the electronic apparatus 10 stops the transmission of time data when a processing delay occurs. (time t21 to t22) during the transmission of time data. Then, the electronic apparatus 10 transmits the retry synchronization signal after a fixed period of time passes without transmitting the end signal (time t25 to t26). The transmission time of the retry synchronization signal is shorter than the transmission time of the initial synchronization signal. For example, the transmission time of the retry synchronization signal is half of the transmission time of the initial synchronization signal. After that, the electronic apparatus 10 transmits the start signal (time t27 to time t28). Then, the electronic apparatus 10 transmits time data (time t29 to t30). After that, the electronic apparatus 10 transmits the end signal in the case where the processing delay does not occur during the transmission of time data (time t31 to t32).

Next, the communication method in the communication system 1 will be explained with reference to FIG. 4 and FIG. 5. FIG. 4 is a flowchart showing processing procedures of communication processing executed by the electronic apparatus 10 according to the embodiment.

(Step S101) The transmission controller 102 controls the light source 103 to transmit the synchronization signal for a fixed period. After that, the process proceeds to Step S102.

(Step S102) The transmission controller 102 controls the light source 103 to transmit the start signal after the transmission of the synchronization signal is completed. After that, the process proceeds to Step S103.

(Step S103) The transmission controller 102 controls the light source 103 to transmit 1-bit time data. At this time, the transmission controller 102 acquires a period of time from the start of transmission to the end of transmission of 1-bit time data. For example, the transmission controller 102 calculates the difference between the time before transmission and the time after transmission, thereby acquiring the period of time from the start of transmission to the end of transmission of 1-bit time data. The transmission controller 102 also acquires the period of time from the start of transmission to the end of transmission of 1-bit time data, for example, by starting counting by setting a timer at the time of starting transmission of 1-bit time data and stopping the timer at the time of ending transmission of 1-bit time data. After that, the process proceeds to Step S104.

(Step S104) The transmission controller 102 determines whether a processing delay has occurred or not in Step S103. Specifically, the transmission controller 102 determines whether the period of time from the start of transmission to the end of transmission of 1-bit time data is equal to or longer than a predetermined period of time. Then, the transmission controller 102 determines that the processing delay does not occur when the period of time from the start of transmission to the end of transmission of 1-bit time data is shorter than the predetermined period of time. The transmission controller 102 determines that the processing delay has occurred when the period of time from the start of transmission to the end of transmission of 1-bit time data is equal to or longer than the predetermined period of time. The process proceeds to Step S105 when the transmission controller 102 determines that the processing delay does not occur. The process proceeds to Step S107 when the transmission controller 102 determines that the processing delay has occurred.

(Step S105) The transmission controller 102 determines that all time data has been transmitted or not. The process proceeds to Step S106 when the transmission controller 102 determines that all time data has been transmitted. The process returns to Step S103 when the transmission controller 102 determines that all time data has not been transmitted.

(Step S106) The transmission controller 102 controls the light source 103 to transmit the end signal. After that, the process ends.

(Step S107) The transmission controller 102 transmits the retry synchronization signal after a fixed period of time passes from the determination that the processing delay has occurred in Step S104. After that, the process returns to Step S102.

FIG. 5 is a flowchart showing processing procedures of communication processing executed by the electronic timepiece 20 according to the embodiment.

(Step S200) The control circuit 202 controls the switch 203 to control transition between the communication period and the charging period periodically. After that, the process proceeds to Step S201.

(Step S201) The control circuit 202 determines whether the apparatus is in the communication period at present or not. When the control circuit 202 determines that the apparatus is in the communication period, the process proceeds to Step S202. When the control circuit 202 determines that the apparatus is not in the communication period, the process returns to Step S200.

(Step S202) The control circuit 202 determines whether the synchronization signal has been received through the solar cell 201 or not. The process proceeds to Step S203 when the control circuit 202 determines that the synchronization signal has been received. The process returns to Step S200 when the control circuit 202 determines that the synchronization signal has not been received.

(Step S203) The control circuit 202 determines whether the start signal has been received through the solar cell 201 or not. The process proceeds to Step S204 when the control circuit 202 determines that the start signal has been received. The process returns to Step S200 when the control circuit 202 determines that the start signal has not been received.

(Step S204) The control circuit 202 receives time data through the solar cell 201. After that, the process proceeds to Step S205.

(Step S205) The control circuit 202 determines that the end signal has been received through the solar cell 201 or not. The process proceeds to Step S206 when the control circuit 202 determines that the end signal has been received. The process proceeds to Step S208 when the control circuit 202 determines that the end signal has not been received.

(Step S206) The control circuit 202 turns on the switch 203 and shifts the period to the charging period. After that, the process proceeds to Step S207.

(Step S207) The control circuit 202 corrects the time based on time data received in the process of Step S204. After that, the process returns to Step S200.

(Step S208) The control circuit 202 determines whether the retry synchronization signal has been received during the predetermined period of time through the solar cell 201 or not. The process returns to Step S203 when the control circuit 202 determines that the retry synchronization signal has been received during the predetermined period of time. The process returns to Step S200 when the control circuit 202 determines that the retry synchronization signal has not been received after the predetermined period of time passes.

As described above, the transmission controller 102 of the electronic apparatus 10 determines whether the delay occurs or not in transmission processing of time data and re-transmits time data when the delay occurs in transmission processing in the embodiment. Accordingly, for example, in the case where the delay occurs in transmission processing of time data due to the processing load applied to the electronic apparatus 10, time data can be positively transmitted to the electronic timepiece 20. Accordingly, the time of the electronic timepiece 20 can be corrected accurately even in the electronic apparatus 10 in which garbage collection and so on frequently occur due to system constraints.

The entire or part of functions of respective components included in the electronic apparatus 10 or the electronic timepiece 20 according to the embodiment may be realized by recording a program for realizing these functions in computer-readable recording media, allowing the program recorded in the recording media to be read by a computer system and executing the program. The computer system in this case includes hardware such as OS and peripheral devices.

The “computer-readable recording media” include removable media such as a flexible disk, a magneto-optical disk, a ROM, and a CD-ROM, and storage units such as a hard disk built in the computer system. The “computer-readable recording media” may further include media dynamically holding the program for a short period of time such as communication lines used when transmitting the program through the communication lines such as networks including Internet and a telephone line as well as include media holding the program for a fixed period of time such as a nonvolatile memory inside the computer system to be a server or a client in the above case. The program may be one for realizing part of the above functions and may be one for realizing the above functions in combination of a program already recorded in the computer system.

The embodiment has been explained as the above, however, the present invention is not limited to the above embodiment and various alterations may occur within a scope not departing from the gist of the present invention. For example, the charging period and the communication period in which optical communication is performed are periodically repeated in the above embodiment, however, the present invention is not limited to the above. The charging period and the communication period may be shifted by controlling the switch 203 in accordance with the charging state of the secondary battery 204.

Also in the above embodiment, the electronic apparatus 10 shows whether the transmission of time data has been succeeded (time data has been transmitted without occurrence of the processing delay) or not based on whether the end signal has been transmitted or not, however, the present invention is not limited to the above. The failure in transmission of time data (occurrence of the processing delay) may be shown by a pulse train having a particular pattern. For example, the success in transmission of time data may be shown by the end signal and the failure in transmission of time data may be shown by an incomplete signal.

Also in the above embodiment, the electronic apparatus 10 determines whether the processing delay occurs or not every time 1-bit time data is transmitted, however, the timing of determining the processing delay is not limited to the above, and whether the processing delay occurs or not may be determined every time plural-bits of time data is transmitted.

Also in the above embodiment, time data is re-transmitted until the time data can be transmitted without generating the processing delay, however, the present invention is not limited to the above, and the number of re-transmission (for example, ten times) may be limited.

Also in the above embodiment, the electronic apparatus 10 re-transmits time data after a fixed period of time passes in the case where the delay occurs in transmission processing of time data, however, the present invention is not limited to the above. For example, time data may be re-transmitted when the processing load of the electronic apparatus 10 is reduced. It is also preferable that the electronic apparatus 10 stores the timing at which the processing load is applied in advance and re-transmits time data while avoiding the timing.

### REFERENCE SIGNS LIST

1 communication system
10 electronic apparatus
20 electronic timepiece
101 time data acquisition unit
102 transmission controller
103 light source
104 clocking unit
201 solar cell
202 control circuit
203 switch
204 secondary battery
205 diode
206 reference signal generating circuit
FIG. 1
10 ELECTRONIC APPARATUS
101 TIME DATA ACQUISITION UNIT
102 TRANSMISSION CONTROLLER
103 LIGHT SOURCE
104 CLOCKING UNIT
20 ELECTRONIC TIMEPIECE
201 SOLAR CELL
202 CONTROL CIRCUIT
POWER SUPPLY TERMINAL
CONTROL TERMINAL
INPUT TERMINAL
GND TERMINAL
206 REFERENCE SIGNAL GENERATING CIRCUIT
FIG. 2
(A) TRANSMISSION TIMING
SYNCHRONIZATION SIGNAL
START SIGNAL
TIME DATA
END SIGNAL
LOW COMMUNICATION RATE
HIGH COMMUNICATION RATE
(B) REFERENCE SIGNAL
(C) OUTPUT TIMING OF SWITCH CONTROL SIGNAL
LOW COMMUNICATION RATE
LOW COMMUNICATION RATE
HIGH COMMUNICATION RATE
LOW COMMUNICATION RATE
TIME
FIG. 3
(A) TRANSMISSION TIMING
START SIGNAL
TIME DATA
END SIGNAL
(B) TRANSMISSION TIMING
OCCURRENCE OF DELAY
NO END SIGNAL
RETRY SYNCHRONIZATION SIGNAL
START SIGNAL
TIME DATA
END SIGNAL
RETRY COMMUNICATION
TIME
FIG. 4
S101 TRANSMIT SYNCHRONIZATION SIGNAL
S102 TRANSMIT START SIGNAL
S103 TRANSMIT 1-BIT TIME DATA
S104 DELAY OCCURS?
S105 ALL TIME DATA HAS BEEN TRANSMITTED?
S106 TRANSMIT END SIGNAL
S107 TRANSMIT RETRY SYNCHRONIZATION SIGNAL
FIG. 5
S200 TURN ON/OFF SWITCH TO PROVIDE COMMUNICATION PERIOD (OFF-PERIOD) AND CHARGING PERIOD (ON-PERIOD)
S201 COMMUNICATION PERIOD (OFF PERIOD)
S202 SYNCHRONIZATION SIGNAL HAS BEEN RECEIVED?
S203 START SIGNAL HAS BEEN RECEIVED?
S204 RECEIVE TIME DATA
S205 END SIGNAL HAS BEEN RECEIVED?
S206 TURN ON SWITCH TO RETURN TO CHARGING PERIOD (ON-PERIOD)
S207 CORRECT TIME
S208 RETRY SYNCHRONIZATION SIGNAL HAS BEEN RECEIVED?

1. A communication system comprising:
a first electronic apparatus; and
a second electronic apparatus,
wherein the first electronic apparatus includes
a transmission unit transmitting an optical signal, and
a transmission controller transmitting data to the second electronic apparatus as the optical signal by using the transmitting unit, determining whether a delay has occurred in transmission of the data or not and re-transmitting the data by using the transmission unit when determining that the delay has occurred, and
the second electronic apparatus includes
a receiving unit receiving the optical signal of the data from the first electronic apparatus, and
a controller enabling the data which has been normally received in the case where the receiving unit has received the data plural times.

2. The communication system according to claim 1,
wherein the transmission controller determines that the delay has occurred in transmission of the data in the case where a period of time from the start of transmission to the end of transmission of the data is equal to or longer than a predetermined period of time.

3. The communication system according to claim 1,
wherein the transmission controller re-transmits the data after transmitting a retry synchronization signal when re-transmitting the data, and
the controller enables data received after the retry synchronization signal when the receiving unit receives the retry synchronization signal.

4. The communication system according to claim 1,
wherein the transmission controller transmits the data after a predetermined period of time passes when re-transmitting the data.

5. The communication system according to claim 1,
wherein the transmission controller transmits an end signal when transmitting the data is completed, and
the controller enables the data received just before the end signal.

6. An electronic apparatus comprising:
a transmission unit transmitting an optical signal; and
a transmission controller transmitting data to another electronic apparatus as the optical signal by using the transmitting unit, determining whether a delay has occurred in transmission of the data or not and re-transmitting the data by using the transmission unit when determining that the delay has occurred.

7. An electronic apparatus comprising:
a receiving unit receiving an optical signal of data from another electronic apparatus; and
a controller enabling the data which has been normally received in the case where the receiving unit has received the data plural times.

8. A communication method in a communication system including a first electronic apparatus and a second electronic apparatus, comprising the steps of:
performing transmission control by transmitting data to the second electronic apparatus as an optical signal by using a transmission unit which transmits the optical signal by the first electronic apparatus, determining whether a delay has occurred in transmission of the data or not and re-transmitting the data by using the transmission unit when occurrence of the delay is determined;
receiving the optical signal of the data from the first electronic apparatus by the second electronic apparatus; and
performing control of enabling the data which has been normally received when the data has been received plural times by the second apparatus in the receiving step.

9. A program for allowing a computer to execute the step of:
performing transmission control by transmitting data to another electronic apparatus as an optical signal by using a transmission unit which transmits the optical signal, determining whether a delay has occurred in transmission of the data or not and re-transmitting the data by using the transmission unit when occurrence of the delay is determined.

10. A program allowing a computer to execute the steps of:
receiving an optical signal of data from another electronic apparatus; and
performing control of enabling the data which has been normally received when the data has been received plural times in the receiving step.
